(19) United States
(12) Patent Application Publication
(10) Pub. No.: US 2017/0219031 A1
(43) Pub. Date: Aug. 3, 2017

(54) BRAKE LINING IN DISC BRAKES, IN PARTICULAR OF VEHICLES, HAVING A GROOVE CONFIGURATION IN THE FRICTION LINING

(71) Applicant: TMD Friction Services GmbH, Leverkusen (DE)

(72) Inventor: Wolfgang HOFFRICHTER, Koln (DE)

(73) Assignee: TMD Friction Services GmbH, Leverkusen (DE)

(21) Appl. No.: 15/500,813

(22) PCT Filed: May 18, 2016
(86) PCT No.: PCT/EP2016/061076

§ 371 Date: Jan. 31, 2017

(30) Foreign Application Priority Data
May 21, 2015 (DE) 10 2015 108 049.4

(51) Int. Cl. F16D 65/092; F16D 69/00

(52) U.S. Cl. CPC F16D 65/092; F16D 69/00; F16D 2069/004

(57) ABSTRACT

The invention relates to a brake lining for disc brakes, in particular for vehicles, having a groove configuration in the friction lining. The groove extends from the entry side to the exit side of the brake lining and converges towards the exit side.

### CROSS-REFERENCE TO RELATED APPLICATIONS

This application is a national stage application (under 35 USC §371) of PCT/EP2015/061076, filed May 18, 2016, which claims benefit of German application No. 10 2015 108 049.4, filed May 21, 2015, the contents of each of which are incorporated by reference herein.

### BACKGROUND OF THE INVENTION

### Technical Field and State of the Art

The invention relates to a brake lining for disc brakes, especially for vehicles, with a groove configuration in the friction lining.

Such a groove configuration in friction linings is disclosed in German patent application DE 40 36 908 A1. In this context, at least one groove is formed in a surface of the brake lining facing the friction counterpart in such a way that, starting from the front edge of the friction lining, said groove tapers steadily in the direction of rotation of the friction counterpart, whereby the groove length amounts to 30% to 60% of the lining width and the maximal groove depth amounts to about two-thirds of the thickness of the friction lining. The groove can form an angle between 75° and 105° relative to the radius or the axial section of the friction counterpart. The groove can be vertical, diagonal or curved.

A drawback of these prior-art friction linings is that undesired residual torques cannot be avoided. Residual torques occur when the brake is not completely lifted at the end of the braking operation, that is to say, the friction linings are not completely released due to the friction in the guide of the brake in the case of sliding-caliper disc brakes or due to the friction of the linings in the guide of the brake mount. This leads to contact between the brake linings and the brake disc, giving rise to the residual torques. Residual torques can occur with non-grooved as well as with conventionally grooved linings.

Even if the linings are properly released, aerodynamic effects at vehicle speeds above 120 km/h can cause the linings to be “suctioned” by the brake disc, likewise leading to significant residual torques in the non-braked state. A residual torque of about 1 Nm that is present on all four wheels can cause additional CO₂ emissions of up to 2 grams.

Before this backdrop, an objective of the present invention is to put forward a brake lining with the features of the above-mentioned type in order to prevent an undesired residual torque on the brake disc, thus achieving a reduction in fuel consumption and CO₂ emissions, especially in motor vehicles.

### SUMMARY OF THE INVENTION

The brake lining has a friction lining with at least one groove formed on the lining surface facing the friction counterpart, especially a brake disc. According to one embodiment of the invention, the groove extends over the lining surface in the rotational direction of the friction counterpart, from the entry side of the friction lining to the exit side. In this process, the groove depth varies from the entry side to the exit side of the friction lining. Such a groove configuration makes it possible to utilize air-flow conditions stemming from the rotation of the brake discs in order to press the brake linings towards the outside, thus releasing them and consequently reducing the residual torques.

When the brake is released and the motor vehicle then moves, the fact that the groove extends over the entire surface of the lining causes an axial force to act more uniformly, pressing the friction lining away from the brake disc. This ensures that the brake lining always comes away from the brake disc, especially at high speeds at which residual torques have a particularly pronounced effect on the CO₂ emissions. The lining is not tilted, that is to say, the friction lining does not come to rest with one edge against the brake disc, thereby likewise reducing the occurrence of residual torques. When the brake is released, the friction lining is moved into a position in which there is no contact between the friction lining and the brake disc, so that ultimately no undesired residual torque is exerted onto the brake disc. As a result, the residual torque is reduced and the fuel consumption and CO₂ emissions of a motor vehicle are reduced.

According to a first advantageous embodiment of the invention, it is provided for the groove depth to diminish, preferably steadily, from the entry side to the exit side of the friction lining. This further improves the air-flow conditions and further reduces the residual torques.

According to another particularly advantageous embodiment of the invention, the groove depth on the entry side goes almost down to the mounting plate of the brake lining, preferably while maintaining a distance of at least 2 mm to 3 mm from the mounting plate. In this manner, if the wear limits of the friction lining are adhered to, protection is also provided against corrosion of the mounting plate and against detachment of the friction lining from the mounting plate.

In a refinement of the invention, it is provided that the groove depth converges with the lining surface towards the exit side. This makes it possible to even further enhance the air cushion effect and thus to reduce the residual torques. This measure also contributes to reducing the CO₂ emissions and the fuel consumption in motor vehicles.

In a refinement of the invention, it is provided that the groove extends over the lining surface diagonally or horizontally or else in a circular-segmented layout from the entry side to the exit side. These configurations of the groove allow the air-flow conditions to be optimally utilized in order to press the brake linings towards the outside. This reduces the residual torques even further. In one embodiment of the invention, it is provided for the groove width to vary from the entry side to the exit side.

According to an alternative embodiment, it is provided that the groove width diminishes, preferably steadily, from the entry side to the exit side. Tapering of the groove width is especially advantageous because this allows a greater dynamic air pressure to be built up. The higher this dynamic air pressure, the greater the axial force that presses the brake lining away from the brake disc.

According to another especially advantageous embodiment of the invention, the groove has a V-shaped or U-shaped cross section. Wear and tear of the lining reduces the width of a groove that has a V-shaped or U-shaped cross section. This is compensated for in that the compressibility of the brake lining diminishes in response to wear and tear of the lining which, due to braking with high braking forces, reduces the residual forces and thus also the residual torques.

Particularly in the case of braking with high braking forces, for example, emergency braking, the entire brake system, including the brake lining, is greatly deformed axially. Rubber gaskets in the braking cylinder that are intended to ensure recovery then slip. As a result, in extreme cases, it is no longer ensured that the lining will be released. This effect is more pronounced in new linings than in worn and thus softer linings since the compressibility is greater. Consequently, worn linings will not deform axially as greatly under an identical braking force. This simplifies the release of the lining brought about by the groove configuration. Owing to its V-shaped or U-shaped cross section, the groove is advantageously adapted to these conditions.

In a refinement of the invention, it is provided for the groove to be arranged on the lining surface of the brake lining on the piston side facing the friction counterpart and/or on the side of the sliding-caliper brake that is opposite from the piston.

In sliding-caliper brakes, a brake piston exerts an axial braking force. An inner brake lining is pressed by the brake piston while an outer brake lining is pressed by a moving caliper against the friction counterpart, for instance, a brake disc. The outer brake lining is pressed by the reaction force that is applied by the brake caliper with the same axial force as the inner brake lining is pressed against the brake disc. For this reason, the inner brake lining can be released sooner, that is to say, it can come away from the brake disc. This reduces the residual force and thus the residual torque. The outer lining has more residual force and thus residual torque since the guide of the brake caliper exhibits friction, which makes the release more difficult. For this reason, it is advantageous to create the groove on the outer brake lining, as set forth in the invention, and for purposes of enhancing the release effect, it is likewise conceivable to arrange the groove on the outer and inner brake linings.

However, it is likewise conceivable to arrange the groove on the inside of the lining or else on both sides.

Additional objectives, advantages, features and application possibilities of the present invention ensue from the description below of an embodiment with reference to the drawing. In this context, all of the described and/or depicted features, either on their own or in any meaningful combination, constitute the subject matter of the present invention, also irrespective of their compilation in the claims or in the claims to which they refer back.

### DESCRIPTION OF THE DRAWINGS

The following is shown:

FIGS. 1 a-1c a perspective view of the brake lining with a groove configuration that extends horizontally over the entire lining surface, in side views and in a top view;

FIGS. 2a-2c a view according to FIG. 1 but with a diagonal groove configuration;

FIGS. 3a-3c a view according to FIG. 1 but with a circular-segmented groove configuration;

FIG. 4 a perspective view of the brake lining with a horizontal groove configuration and a constant groove width; and

FIG. 5 a perspective view of a sliding caliper brake lining with a horizontal groove configuration.

### DETAILED DESCRIPTION

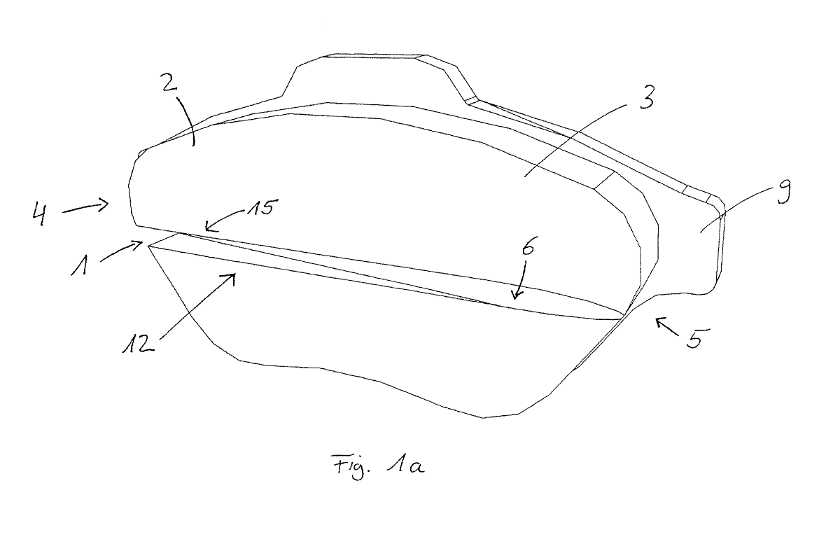

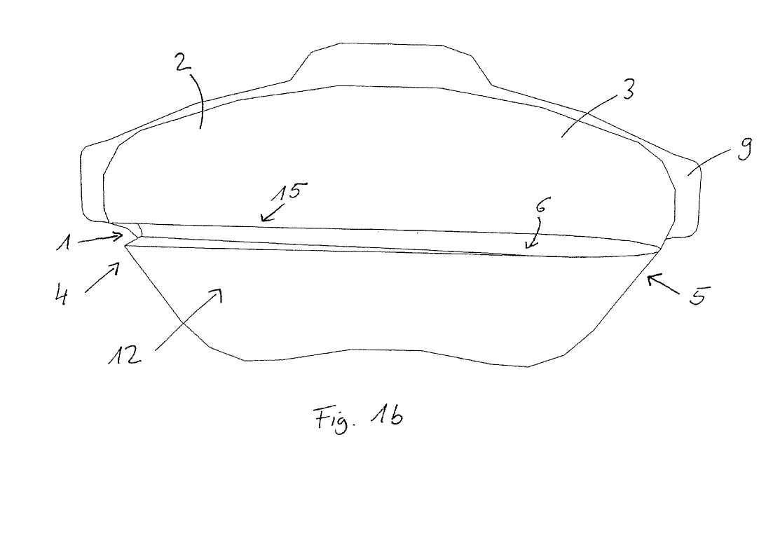

FIG. 1 shows a brake lining with a mounting plate 9 and a friction lining 3 arranged thereupon. The friction lining 3 has the groove 1 formed on the lining surface 2 facing a friction counterpart, especially a brake disc.

As can be seen in FIG. 1a, this groove 1 extends approximately horizontally over the lining surface 2 from an entry side 4 of the friction lining 3 to an exit side 5. The groove depth varies 14, preferably tapering from the entry side 4 to the exit side 5 of the friction lining 3.

As can be seen in FIGS. 1a to 1c, the groove width 15 also tapers steadily from the entry side 4 to the exit side 5. Owing to this configuration of the groove 1 on the surface 2 of the friction lining 3, it is possible to avoid an undesired residual torque that acts upon the brake disc. Residual torques occur in that the brake is not completely lifted at the end of a braking operation, that is to say, the lining is not completely released.

Due to the rotation of the brake disc when the motor vehicle is moving, when the brake is released, such a groove configuration allows the air-flow conditions to be utilized to press the friction lining towards the outside and thus release it, thereby reducing the residual torques. As a result, the air cushion effect is enhanced even further, thereby reducing residual torques. According to FIGS. 1a to 1c, when the motor vehicle is moving forward, the groove 1 extends in the rotational direction of the brake disc approximately horizontally over the lining surface 2 from the entry side 4 towards the exit side 5. A reduction of the residual torque has the positive effect of reducing the fuel consumption and CO₂ emissions of motor vehicles.

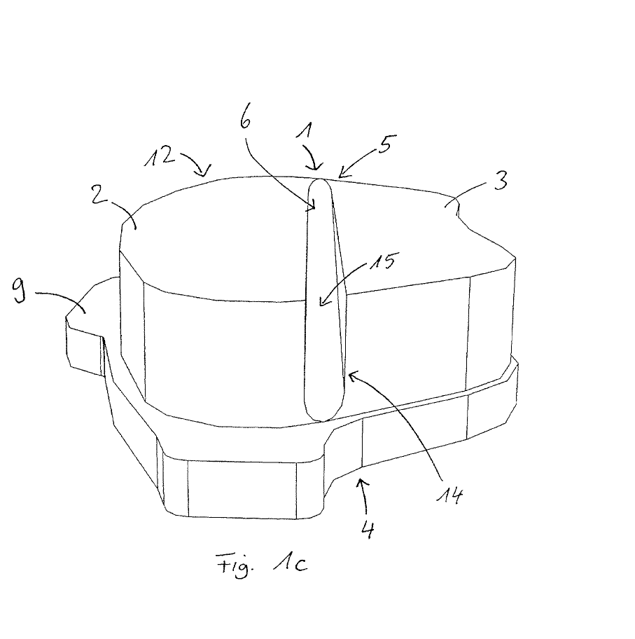

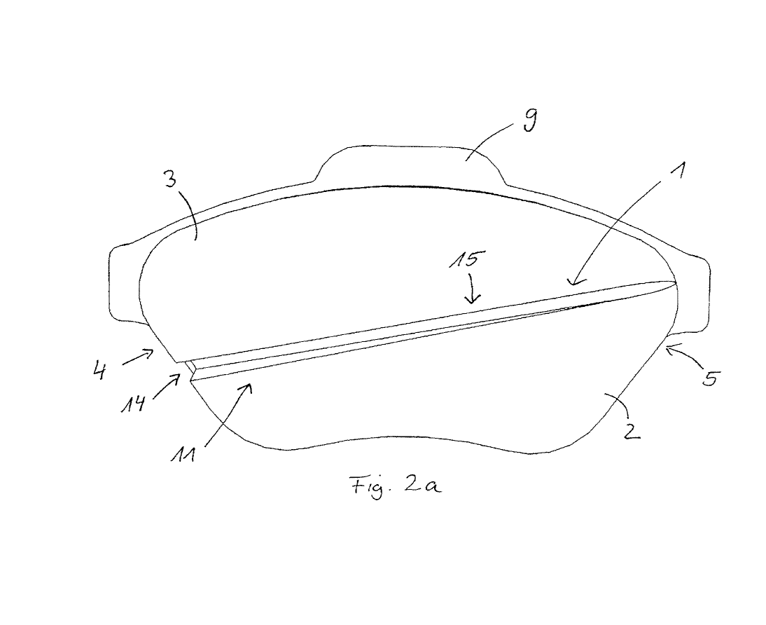

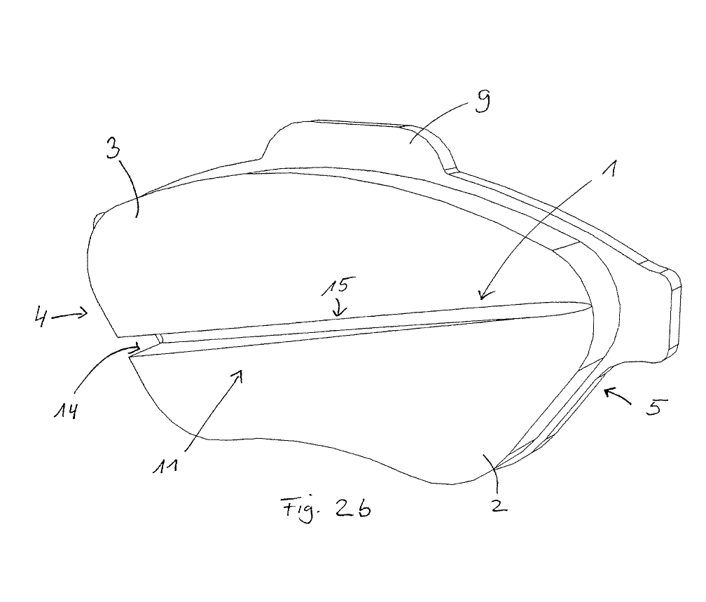

FIGS. 2a to 2c show an alternative embodiment of the groove 1 on the surface 2 of the friction lining 3. Here, the groove 1 extends approximately diagonally over the friction lining 3 from the entry side 4 to the exit side 5 of the friction lining 3.

The axial force that results from the configuration of further improved air-flow conditions and that presses the friction lining 3 away from the brake disc becomes more uniform, as a result of which a defined release of the friction lining 3 from the brake disc is ensured and no undesired tilting of the friction lining 3 occurs.

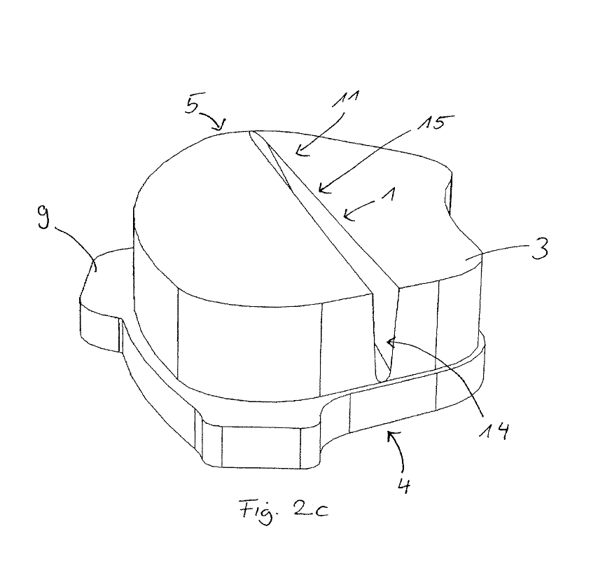

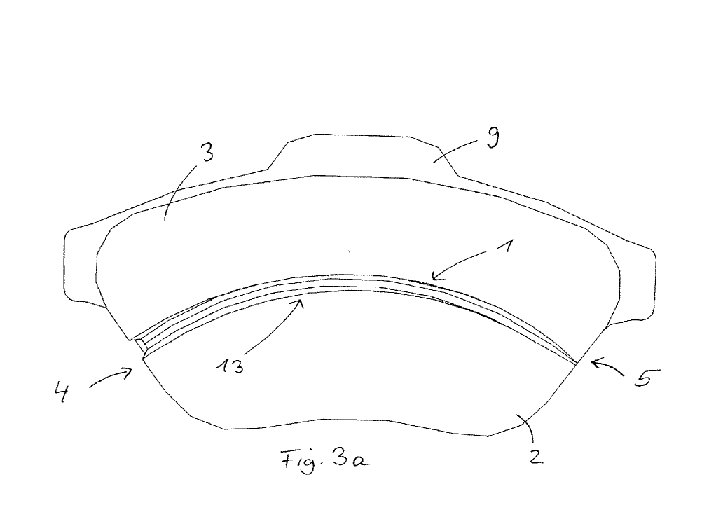

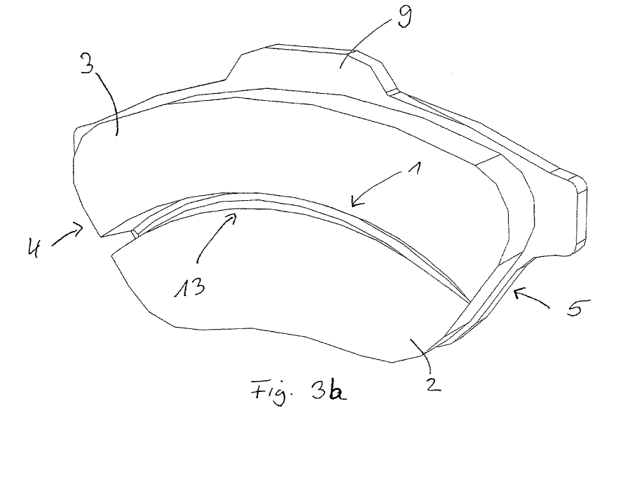

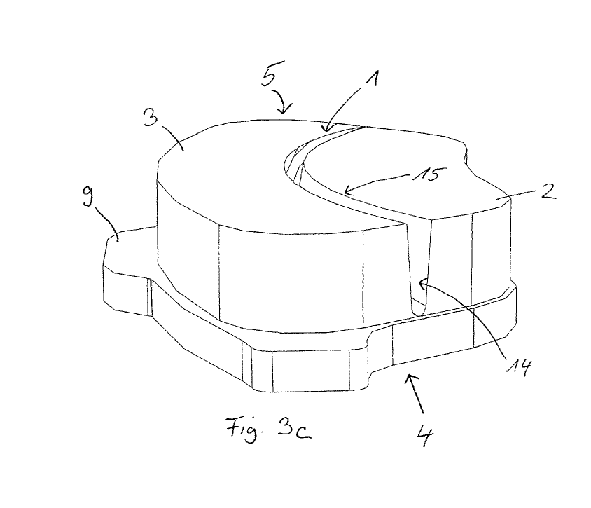

As can be seen in FIGS. 3a to 3c, it can also be provided that the groove 1 extends over the lining surface 2 in a somewhat circular-segmented or semi-circular segmented layout from the entry side 4 to the exit side 5. Also in this embodiment, the groove depth 14 and the groove width 15 vary in that they decrease steadily from the entry side 4 to the exit side 5. This embodiment is advantageous because it allows a further improvement of the air-flow conditions.

Due to the tapering of the groove depth 14 and of the groove width 15, a greater dynamic air pressure can build up between the brake lining and the brake disc when the brake is released. This brings about a greater axial force between the brake lining and the brake disc, so that residual torques are reduced and the friction lining 3 is released.

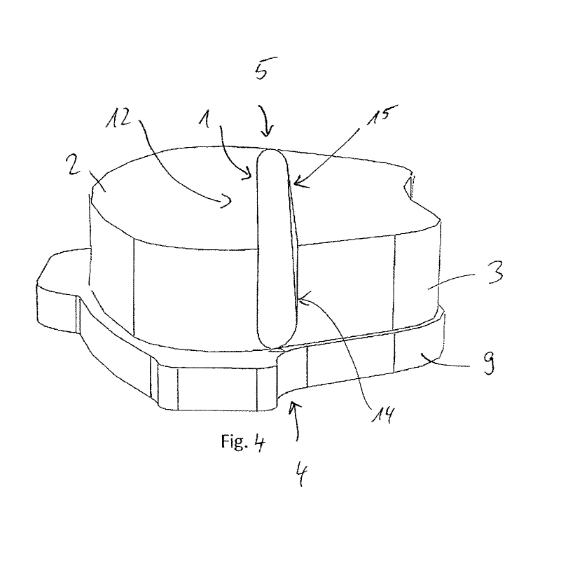

FIG. 4 shows an embodiment of the groove 1 over the lining surface 2 of the friction lining 3 which differs from the embodiment according to FIG. 1 in that, even though the groove depth 14 varies from the entry side 4 to the exit side 5, the groove width 15 remains constant over the lining surface 2 of the friction lining 3. Naturally, a combination of a constant groove width 15 with a diagonal or circular-segmented configuration of the groove 1 extending over the lining surface 2 from the entry side 4 to the exit side 5 is likewise conceivable. This embodiment of the groove 1 is also able to further improve the air-flow conditions.

In another embodiment of the groove 1, it can be provided that the groove 1 has a V-shaped or U-shaped cross section. Due to wear and tear of the friction lining 3, the groove width 15 in V-shaped or U-shaped grooves decreases.

This is compensated for by the fact that the compressibility of the friction lining 3 decreases. After all, under an identical braking force, worn linings deform axially to a lesser extent since the compressibility of worn and thus softer linings is higher.

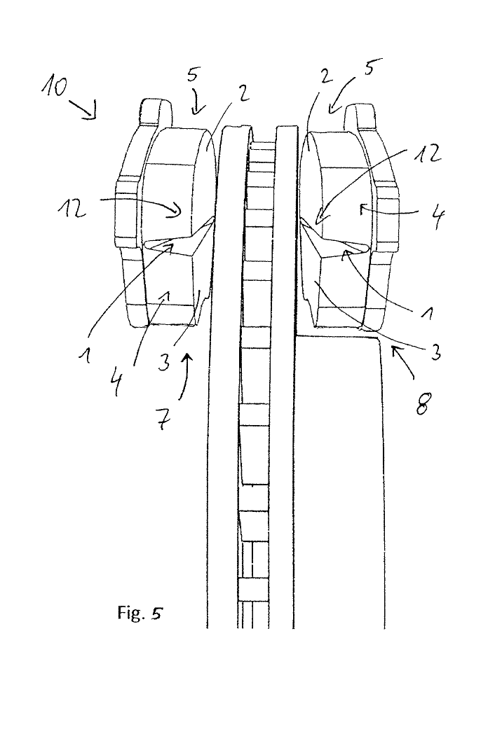

FIG. 5 schematically shows a sliding caliper brake 10. In sliding caliper brakes 10, an axial braking force causes an inner brake lining to be pressed by a brake piston and causes an outer brake lining to be pressed onto a brake lining by a moving caliper. The reaction force that is brought to bear by the brake caliper causes the outer brake lining to be pressed onto the brake disc with the same axial force as the inner brake lining. For this reason, the inner brake lining can be released earlier, that is to say, can come away from the brake disc. Thanks to the formation of the groove 1 on the outer brake lining 7 and/or on the inner brake lining, the residual force and thus the residual torque are reduced.

### LIST OF REFERENCE NUMERALS

1 groove
2 lining surface
3 friction lining
4 entry side
5 exit side
6 groove surface/groove top
7 outer brake lining
8 brake lining on the piston side
9 mounting plate
10 sliding caliper
11 diagonal groove
12 horizontal groove
13 circular-segmented groove
14 groove depth
15 groove width

1. A brake lining for disc brakes for motor vehicles, comprising:
a friction lining (3) arranged on a lining mounting plate (9), said friction lining (3) having a lining surface (2) with an entry side (4) and an exit side (5), and defining in its lining surface (2) at least one groove (1) that extends over the lining surface (2) in the rotational direction of a friction counterpart with which the friction lining (3) interacts during a braking operation, from the entry side (4) of the friction lining (3) to the exit side (5) and converges with the lining surface (2) towards the exit side (5).

2. The brake lining according to claim 1, wherein the groove (1) has a groove depth (14) that varies from the entry side (4) to the exit side (5) of the friction lining (3).

3. The brake lining according to claim 1, wherein the groove (1) has a groove depth (14) that decreases from the entry side (4) to the exit side (5) of the friction lining (3).

4. The brake lining according to claim 1, wherein the groove (1) has a groove depth (14) that on the entry side (4) extends to a mounting plate (9) of the brake lining (3).

5. The brake lining according to claim 1, wherein the groove (1) has a groove depth (14) that on the entry side (4) extends to a mounting plate (9) of the brake lining (3) while maintaining a distance of at least approximately 2 mm to 3 mm from the mounting plate (9).

6. The brake lining according to claim 1, wherein the groove (1) extends over the lining surface (2) diagonally or horizontally or in a circular-segmented layout from the entry side (4) to the exit side (5).

7. The brake lining according to claim 1, wherein the groove (1) has a groove width (15) that varies from the entry side (4) to the exit side (5).

8. The brake lining according to claim 1, wherein the groove (1) has a groove width (15) that tapers from the entry side (4) to the exit side (5).

9. The brake lining according to claim 1, wherein the groove (1) has a V-shaped or U-shaped cross section.

10. The brake lining according to claim 1, wherein the groove (1) is is formed in the lining surface (2) of the brake lining (8) on the piston side facing the friction counterpart and/or on the side (7) of a sliding-caliper brake (10) that is opposite from the piston.

11. A brake lining for disc brakes for motor vehicles, comprising:
a friction lining having a lining surface and a surface opposite from the lining surface adapted for joining the friction lining to a lining mounting plate, said lining surface having an entry side and an exit side, said friction lining defining in its lining surface at least one groove that extends from the entry side to the exit side and converges with the lining surface towards the exit side.

12. The brake lining of claim 11, wherein the groove has a groove depth that is deeper on the entry side than a groove depth on the exit side

13. The brake lining of claim 11, wherein the groove has a groove width that varies from the entry side to the exit side.
